(19) United States
(12) Patent Application Publication
(10) Pub. No.: US 2004/0086198 A1
(43) Pub. Date: May 6, 2004

(54) System and method for bump height measurement

(76) Inventors: Gerald Brown, Colleyville, TX (US); Richard Goedeken, Richardson, TX (US); Charles Harris, Dallas, TX (US); Hak Sim, Garland, TX (US); Weerakiat Wahawisan, Carrollton, TX (US)

Correspondence Address: CHRISTOPHER J. ROURK, AKIN, GUMP, STRAUSS, HAUER & FELD, L.L.P., P O BOX 688, DALLAS, TX, 75313-0688, US

(21) Appl. No.: 10/288,062

(22) Filed: Nov. 5, 2002

(51) Int. Cl. G06K 9/36; G01C 3/08

(52) U.S. Cl. 382/286; 356/4.08

(57) ABSTRACT

A system for inspecting components is provided. The system includes a light source illuminating a component feature so as to create a specular or non-lambertian reflection off the component feature. An image sensor is positioned to receive the specular or non-lambertian reflection and to generate point brightness data and point position data, such as for a point of light reflected off the component feature. A height measurement system receives the point brightness data and the point position data and generates feature height data.

### FIELD OF THE INVENTION

The present invention pertains to the field of component inspection systems. More specifically, the invention relates to a system and method for component inspection that uses specular or non-lambertian reflection data to measure feature height, such as bump height.

### BACKGROUND OF THE INVENTION

Inspection systems that use image data are known in the art. Such inspection systems typically use image data from a component that has been illuminated by either a coherent or noncoherent source, and then perform image analysis processes on the image data to determine whether the component conforms to predetermined criteria. For example, image data analysis is used to determine whether components have been properly marked, have features in the correct location, or have other specified criteria. In this regard, a “feature” can include a desired feature, such as a contact, or an undesired feature, such as damage on the contact that extends from or into the surface of the contact.

One problem with such component inspection systems is that three-dimensional aspects of the component must be inferred from the image data. Thus, in many cases it is difficult to determine whether an indication in the image data is from a feature that extends above or below a plane of reference. For example, light reflected from objects with a smooth surface or surfaces can include a strong specular component and a relatively weak lambertian component. Analyzing image data generated by light reflected from such components can be complicated by the “noise” generated by the specular reflection.

### SUMMARY OF THE INVENTION

In accordance with the present invention, a system and method for component inspection are presented that overcome known problems with component inspection.

In particular, a system and method for component inspection are provided that utilize characteristics of specular or non-lambertian reflections to determine feature height.

In accordance with an exemplary embodiment of the present invention, a system for inspecting components is provided. The system includes a light source illuminating a component feature so as to create a specular or non-lambertian reflection off the component feature. An image sensor is positioned to receive the specular or non-lambertian reflection and to generate point brightness data and point position data, such as for a point of light reflected off the component feature. A height measurement system receives the point brightness data and the point position data and generates feature height data.

The present invention provides many important technical advantages. One important technical advantage of the present invention is a system and method for inspecting components that uses specular or non-lambertian reflection data to analyze component features. While such specular or non-lambertian reflection data often creates undesirable affects that prevent or complicate the analysis of image data, the present invention uses these effects to locate the height of a feature and other suitable parameters.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1A is a diagram of a system for measuring bump height in accordance with an exemplary embodiment of the present invention;

FIG. 1B is a diagram of a system showing a subsequent step in the process of measuring bump height in accordance with an exemplary embodiment of the present invention;

FIG. 1C is a diagram of a system showing a further step in the inspection process in accordance with an exemplary embodiment of the present invention;

FIGS. 1D, 1E, and 1F show subsequent process steps in accordance with an exemplary embodiment of the present invention;

FIG. 2 is a graph of spot brightness as a function of relative height in accordance with an exemplary embodiment of the present invention;

FIG. 3 is a diagram of a system for inspecting bump contacts and other component features in accordance with an exemplary embodiment of the present invention; and

FIG. 4 is a flow chart of a method for inspecting bump contacts using nonspecular reflection data in accordance with an exemplary embodiment of the present invention.

### DETAILED DESCRIPTION OF THE INVENTION

In the description that follows, like parts are marked throughout the specification and drawings with the same reference numerals, respectively. The drawing figures are not necessarily to scale, and certain components can be shown in generalized or schematic form and identified by commercial designations in the interest of clarity and conciseness.

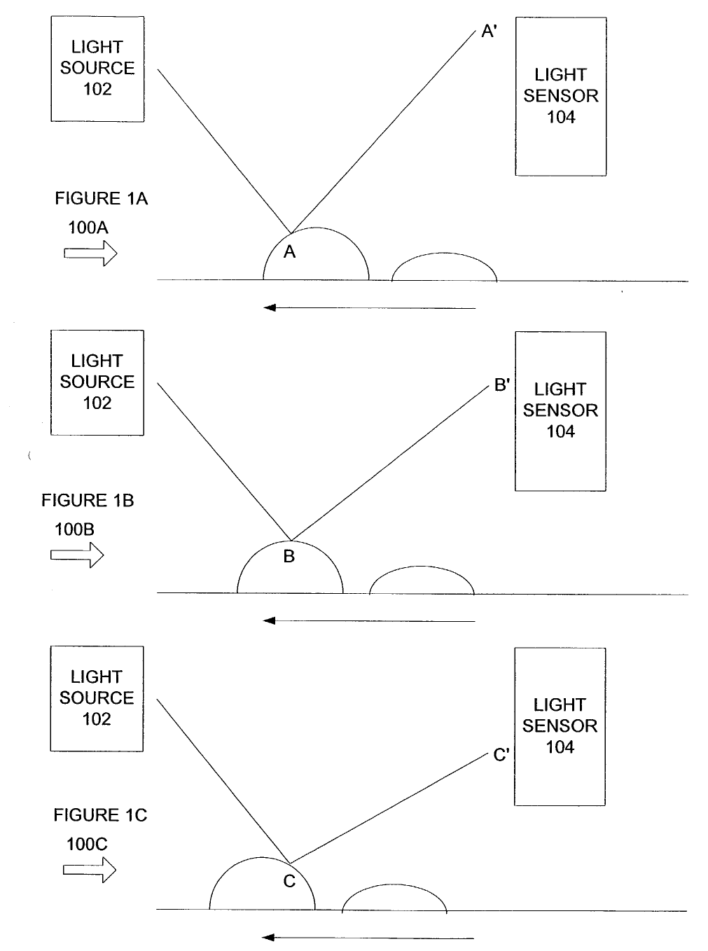

FIG. 1A is a diagram of a system 100A for measuring bump height in accordance with an exemplary embodiment of the present invention. System 100A includes light source 102 and light sensor 104. In one exemplary embodiment, light source 102 can be a laser light source or other concentrated light source that forms a beam, such that the reflection of the light source off a surface forms a defined spot.

Light sensor 104 can include a plurality of pixels in an N×M pixel array, such that the point formed by light source 102 reflecting off an object illuminates one or more pixels of the pixel array of light sensor 104. In this manner, the location of the point of light on light sensor 104 can be determined from the coordinates of the pixels that are illuminated. In addition, the brightness of the point of light can also be measured directly by measuring the brightness at each illuminated pixel. In this exemplary embodiment, the brightness can include compensation for spreading or other factors that cause the point of light to encompass a greater or lesser number of pixels. Likewise, the location of the point of light can be determined using reference points on the sides of an inspection area or another suitable locations, crosshairs on a lens cover, or other suitable procedures can be used.

As shown in FIG. 1A, a beam of light from light source 102 reflects off a first bump at point A and forms a point of light at point A′. The drawing depicts the specular or non-lambertian reflection of the beam of light, such that the angle of incidence is equal to the angle of reflection.

FIG. 1B is a diagram of system 100B showing a subsequent step in the process of measuring bump height. System 100B includes the first bump in a second inspection position, such as where the bumps are being moved in the direction of the arrow in FIGS. 1A through 1F as shown. The beam of light from light source 102 reflects off the first bump at point B, and forms a spot at point B′ on light sensor 104. The drawing depicts the specular or non-lambertian reflection where the angle of incidence of the light beam from light source 102 equals the angle of reflection of the light beam from point B to point B′.

FIG. 1C is a diagram of a system 100C showing a further step in the inspection process. The beam of light from light source 102 reflects off the first bump at point C, forming a point C′ at light sensor 104. Because the reflection can be specular or non-lambertian, the brightness at points A′, B′, and C′ varies such that the brightest point occurs at the top of the bump, or at point B′. In this manner, the height of the first bump can be determined by plotting the change in brightness as a function of position across light sensor 104, where the top of the bump occurs at the point where the brightness of the point on light sensor 104 is at a maximum.

FIGS. 1D, 1E, and 1F show a similar process for systems 100D, 100E and 100F. In these diagrams a second bump is moved in the direction of the arrow and points D, E, and F are illuminated on the second bump. Likewise, points D′, E′, and F′ illuminate light sensor 104 at the positions shown. Because the reflections from the second bump can also be specular or non-lambertian, the brightness varies as a function of position such that the brightest point occurs at point E′. The location on light sensor 104 of point E′ is lower than the location on light sensor 104 of point B′ for a taller bump. Thus, it is possible to measure bump height using the specular reflection, where the relative bump height can be determined based on the peak brightness of a reflected beam of light from a bump.

In operation, systems 100A through 100E can be used to inspect bump contacts or other features to determine whether the height of the bump contacts forms a planar surface, such as within allowable variation specifications, or the height of other features. Using a laser light source that traces a line, an array of bump contacts can be moved across the line, such that the laser light reflects off the bump contacts and is received at a sensor. The height of each bump can be determined based on the brightness of each specular reflected point or other suitable reflection as it travels across light sensor 104. In this manner, an array of bump contacts can be quickly inspected and non-planar contacts can be readily detected, or the height of other features can be readily determined.

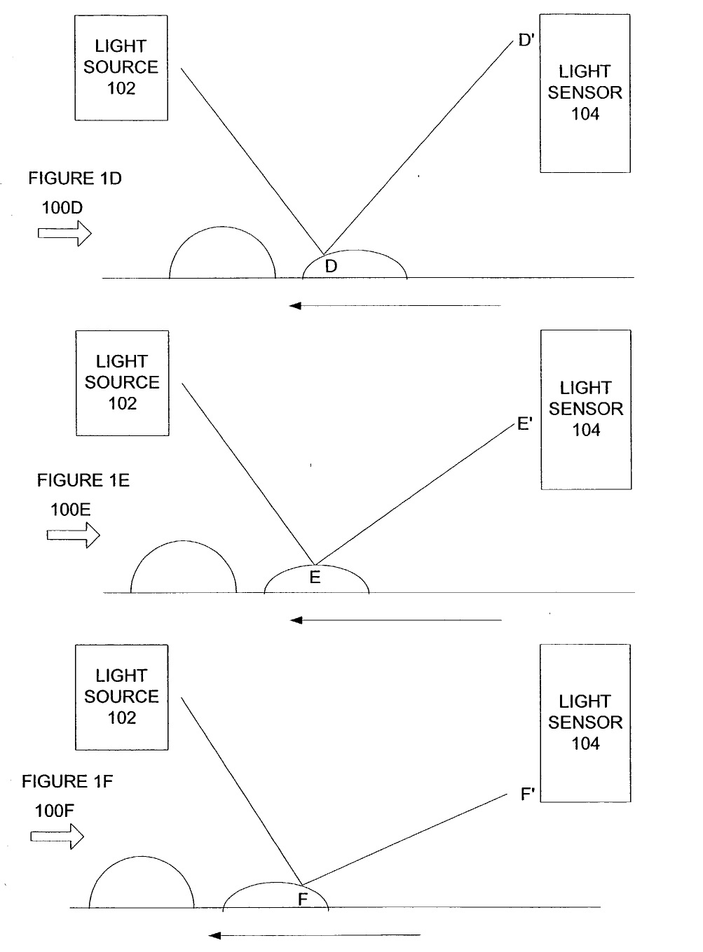

FIG. 2 is a graph 200 of spot brightness as a function of relative height in accordance with an exemplary embodiment of the present invention. The X axis of graph 200 shows relative height, whereas the Y axis shows spot brightness. Thus, the curve formed by points A′, B′, and C′has a peak at a first location that corresponds to the height of the first bump in FIGS. 1A through 1F, whereas the curve formed by the spots D′, E′, and F′ has a peak at a second location that corresponds to a second, lower height. Using this process, it is possible to determine whether the height of the first bump and the second bump are the same, or whether the first bump is taller or shorter than the second bump. Using the peak variations shown in graph 200, the actual height can be calibrated with the relative height shown. In one exemplary embodiment, customer-specified tolerances for contact heights can be used to establish allowable ranges for coplanarity of ball grid arrays or other forms of contact bumps.

Likewise, a similar process can be used for determining the height of a feature other than bump contacts. Such features may generate a line or other reflected images, and the linearity of the line or relative position and brightness of the reflection off other features can also or alternatively be used to determine feature height.

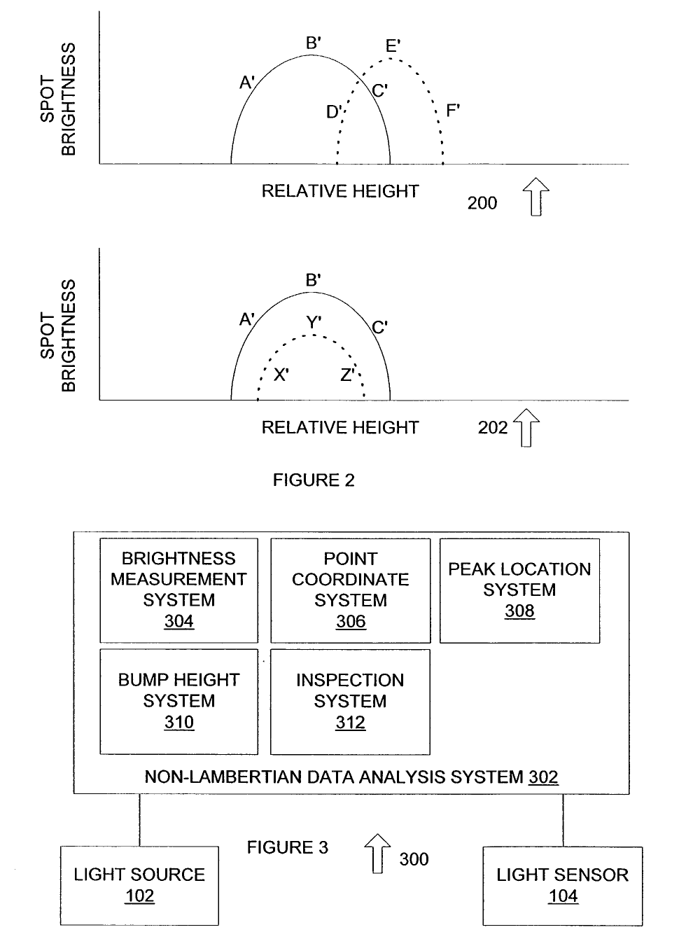

FIG. 3 is a diagram of a system 300 for inspecting bump contacts and other component features in accordance with an exemplary embodiment of the present invention. System 300 includes specular data analysis system 302 and brightness measurement system 304, point coordinate system 306, peak location system 308, and bump height system 310, each of which can be implemented in hardware, software, or a suitable combination of hardware and software, and which can be one or more software systems operating on a general purpose processing platform. In addition, system 300 includes light source 102 and light sensor 104 coupled to specular data analysis system 302. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

Brightness measurement system 304 receives data from light sensor 104 and determines brightness data from the data received from light sensor 104. In one exemplary embodiment, light sensor 104 can include an N×M array of pixels such that brightness measurement system 304 determines the brightness measured at each pixel. Likewise, brightness measurement system 304 can measure the brightness of a group of pixels, such as to determine the area covered by the group of pixels or other suitable data. Brightness measurement system 304 can also control light source 102 to increase or decrease the brightness of light source 102, such as to ensure that the brightness variations are falling within the median range of the measurement capability of the pixels.

Point coordinate system 306 determines the location of a point of brightness impinging on light sensor 104. In one exemplary embodiment, point coordinate system 306 can use coordinate data for each pixel of the N×M pixel array to assign relative height coordinates to a point of light impinging on the array. Likewise, point coordinate system 306 can use crosshairs on a lens cover, height indicators around the periphery or in other locations of the inspection area, or the suitable processes to determine the coordinates of a point of brightness as it tracks across light sensor 104. Point coordinate system 306 can also assign two or more pixels to a point, can compensate for spreading on the point (such as from a spot covering X pixels to a spot covering Y pixels, where X<Y), and can perform other suitable point coordinate measurement and control functions.

Peak location system 308 receives brightness data and point coordinate data and determines the peak brightness location. In one exemplary embodiment, peak location 308 can receive brightness data and point coordinate data for a plurality of points and can form a plurality of curves, such that each point of brightness has its own curve. In this exemplary embodiment, peak location system 308 can use a moving average of a predetermined number of measurement values, can detects when a slope of a curve changes from positive to negative over a suitable range, or can implement other suitable peak location functions or processes.

Bump height system 310 assigns relative or actual bump heights to brightness data measured by specular data analysis system 302. In one exemplary embodiment, bump height system 310 can be calibrated using a series of bumps or other features having known height, can be calibrated such that relative height differences are equated to actual physical measurements, or other suitable processes can be used. Bump height system 310 generates relative or actual bump height data, such as data that can be used to determine whether a single bump height is within a predetermined allowable range, whether a group of bumps have an allowable height variation for purposes of determining coplanarity, or other suitable bump height data.

Inspection system 312 receives bump height data and generates inspection pass/fail data. In one exemplary embodiment, inspection system 312 can receive specification data that includes allowable variation ranges for bump height, relative variation ranges, absolute variation ranges, or other suitable data. For example, each bump contact of a bump contact array can have allowable maximum and minimum height limits, but a second allowable range of height variations for determining coplanarity of the set of bump contacts in the array can also be assigned. In this exemplary embodiment, the height of a group of bumps could be higher or lower than the allowable range, but the group of bumps could have an allowable coplanarity. Likewise, the bump heights could fall within allowable ranges for maximum and minimum height, but the coplanarity of the bumps may be unacceptable. Inspection system 312 can detect such conditions and other conditions, and can generate suitable notification data, such as control data to mark or remove a component, operator notification data, or other suitable data.

In operation, system 300 allows bump contacts to be inspected using specular or non-lambertian reflections of light from the bump contacts. System 300 receives light reflections, such as from a laser beam reflected off bump contacts, and determines a peak brightness that corresponds to the height of each bump contact. System 300 then correlates the location of the brightness peak to a relative or actual bump height, such that compliance with specifications for maximum and minimum bump height, coplanarity, or other suitable bump metrics can be implemented.

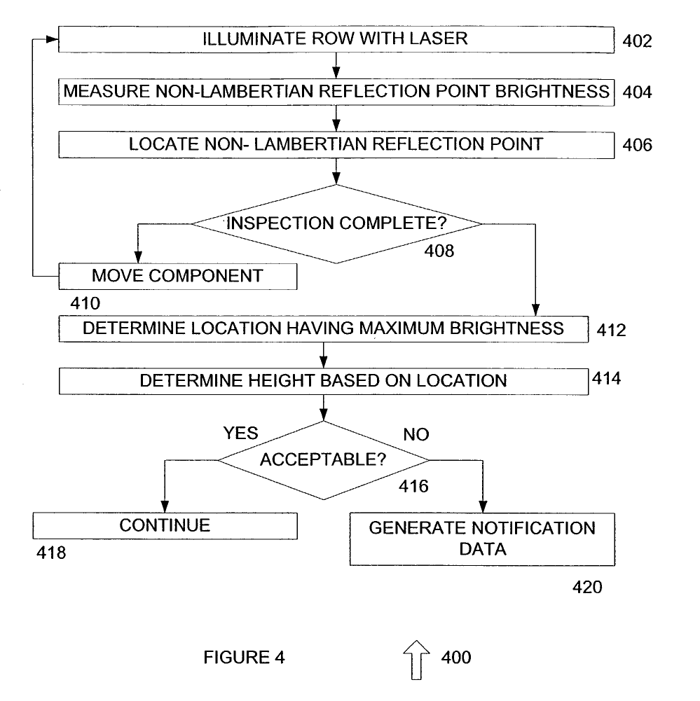

FIG. 4 is a flow chart of a method 400 for inspecting bump contacts using specular reflection data in accordance with an exemplary embodiment of the present invention. Method 400 begins at 402 where a laser or other suitable light source is used to illuminate one or more bump contacts, such as bump contacts in a row or array of contacts. In one exemplary embodiment, the laser can be used to trace a line that is orientated parallel to the orientation of one or more rows of bump contacts, and the rows of bump contacts can be moved towards the line drawn by the laser. The method than proceeds to 404.

At 404 a specular reflection point brightness is measured. In one exemplary embodiment, the specular reflection point brightness can be generated by a specular or non-lambertian bump contact surface, where the brightness and location of the reflection point varies as a function of the location of the beam of light on the bump contact. The method then proceeds to 406.

At 406 the location of the specular or non-lambertian reflection point is determined. In one exemplary embodiment, a pixel array can be used such that the coordinates of the pixel or group of pixels on which the reflection point lands can be used to plot the brightness as a function of location. Likewise, crosshairs on a lens cover, reference points in an inspection area, or other suitable processes can be used to determine the location of a specular or non-lambertian reflection point. The method then proceeds to 408.

At 408 it is determined whether the inspection is completed. In one exemplary embodiment, the number of rows of bump contacts inspected can be tracked, the length of a wafer or die can be used to determine when an entire wafer or die has been inspected, or other suitable processes can be used. If it is determined at 408 that the inspection is not completed the method proceeds to 410 and the component or light source is moved. In one exemplary embodiment, movement can be continuous such that component movement is continued at 410. If it is determined that inspection is completed at 408 the method proceeds to 412.

At 412 the location having maximum brightness is determined. In one exemplary embodiment, brightness values can be measured throughout the range of point movement, after which the stored values can be plotted to determine the location of the peak brightness. In another exemplary embodiment, the location having maximum brightness can be performed after 406, such as by using a moving average of pixel brightness values to track the slope of the curve, such that a change in slope can be used to indicate when a peak has been measured. Other suitable processes can be used. The method then proceeds to 414.

At 414 the height of the bump is determined based on the location having the maximum brightness. In one exemplary embodiment, the height can be used to determine relative height variations, the height can be calibrated so that an absolute height measurement is obtained, or other suitable processes can be used. The method then proceeds to 416.

At 416 it is determined whether the inspection results are acceptable. In one exemplary embodiment, the inspection results can be compared with allowable maximum and minimum height values, allowable height variations for adjacent bump contacts, such as for coplanarity, or other suitable processes can be used. If it is determined at 416 that the bump height is acceptable the method proceeds to 418 and the component handling process continues, such as by performing other inspections, by packaging the component, or by performing other suitable processes. Likewise, if it is determined at 416 that the bump height is not acceptable the method proceeds to 420 where notification data is generated. In one exemplary embodiment, the notification data can include operator identification data, control data for removing the component or marking the component, or the suitable notification data.

In operation, method 400 allows bump contacts to be inspected using specular or non-lambertian reflection data. Method 400 tracks the brightness of a point of light reflected off of bump contacts, where such bump contacts provide specular or non-lambertian reflection characteristics. In this manner, the coplanarity of a ball grid array, chip scale package contacts, or other suitable data can be determined rapidly and accurately.

Although exemplary embodiments of a system and method of the present invention been described in detail herein, those skilled in the art will also recognize that various substitutions and modifications can be made to the systems and methods without departing from the scope and spirit of the appended claims.

What is claimed is:

1. A system for inspecting components comprising:
a light source illuminating a component feature so as to create a non-lambertian reflection off the component feature;
an image sensor positioned to receive the non-lambertian reflection and to generate brightness data and position data; and
a height measurement system receiving the brightness data and the position data and generating feature height data.

2. The system of claim 1 wherein the light source comprises a laser light source.

3. The system of claim 1 wherein the image sensor comprises an array of light sensing pixels, the brightness data comprises pixel brightness data, and the position data comprises pixel address data.

4. The system of claim 1 wherein the height measurement system comprises a brightness measurement system receiving pixel brightness data.

5. The system of claim 1 wherein the height measurement system comprises a point coordinate system receiving pixel address data that locates a plurality of pixels within a pixel array.

6. The system of claim 1 wherein the height measurement system comprises a peak location system receiving the position data and the brightness data and determining a position having a maximum brightness.

7. The system of claim 1 wherein the height measurement system comprises a bump height system determining a bump contact height from the position data and the brightness data.

8. The system of claim 1 further comprising an inspection system receiving the feature height data and generating pass/fail data.

9. A method for measuring a feature comprising:
illuminating the feature with a light source;
measuring a non-lambertian reflection brightness and location as the feature is moved; and
determining a height of the feature based on a location of a peak brightness value.

10. The method of claim 9 wherein illuminating the feature with a light source comprises illuminating the feature with a laser light source.

11. The method of claim 9 wherein measuring the non-lambertian reflection brightness and location as the feature is moved comprises measuring a brightness value at each of a plurality of pixels.

12. The method of claim 9 wherein determining the height of the feature based on the location of the peak brightness value comprises:
determining which of a plurality of pixels is registering a peak brightness value;
determining a location of the pixel registering the peak brightness value from stored pixel coordinate data; and
determining the height based on calibration data related to the stored pixel coordinate data.

13. The method of claim 9 wherein a plurality of features are illuminated using a laser-drawn line.

14. The method of claim 9 further comprising generating pass/fail data based on the height of the feature.

15. A method for inspecting a ball grid array having one or more linear rows of ball contacts, comprising:
generating a laser-drawn line;
aligning the ball grid array so that the linear rows of ball contacts are parallel to the laser-drawn line;
moving the ball grid array towards the laser-drawn line;
measuring the brightness of a reflection from each ball contact; and
determining the point at which the brightness of each point has reached a peak.

16. The method of claim 15 wherein measuring the brightness of the reflection from each ball contact comprises receiving the reflection at a pixel array.

17. The method of claim 15 wherein determining the point at which the brightness of each point has reached the peak comprises:
assigning coordinate data to each of a plurality of pixels in a pixel array; and
tracking the brightness and location of each reflection as it moves across the pixel array.

18. The method of claim 15 wherein determining the point at which the brightness of each point has reached the peak comprises:
storing pixel brightness data for each of a plurality of pixels in a pixel array during a period of time;
isolating a line formed over the period of time in the pixel brightness data; and
determining the pixel in the line having the greatest brightness magnitude.

19. The method of claim 15 wherein determining the point at which the brightness of each point has reached the peak comprises:
plotting a change in brightness over time as a function of position; and
determining where a slope changes from positive to negative.

20. The method of claim 15 further comprising determining a height for each ball contact from the point at which the brightness of each point has reached a peak.
